(19) United States
(12) Patent Application Publication
(10) Pub. No.: US 2006/0155421 A1
(43) Pub. Date: Jul. 13, 2006

(54) System and method for controlling movement of movable terminal for MiniCon

(76) Inventors: Seung-Hyun Baek, Seoul (KR); Hyun-Sik Shim, Yongin-si (KR); Jong-Chang Lee, Suwon-si (KR)

Correspondence Address: Robert E. Bushnell;Suite 300, 1522 K Street, N.W., Washington, DC, 20005, US

(21) Appl. No.: 11/322,266

(22) Filed: Jan. 3, 2006

(30) Foreign Application Priority Data
Jan. 11, 2005 (KR) 2005-2571

(51) Int. Cl. G01M 1/38; G05B 13/00

(52) U.S. Cl. 700/276; 700/277

(57) ABSTRACT

In a system and method for controlling the movement of a movable terminal for a MiniCon through a network, a temperature in a number of partitioned indoor spaces is maintained within a set temperature range desired by a user while the terminal moves in the indoor spaces. The system is provided with at least one MiniCon which performs air-conditioning, and includes: a movable terminal which docks with the MiniCon, and which moves along a predetermined path; and a server which communicates with the movable terminal via a local area network. The server sends, to the movable terminal, a control command for performance of air-conditioning in indoor spaces along the predetermined path. Accordingly, the MiniCon is enabled to freely move into at least one of a number of indoor spaces, and to perform air-conditioning, thereby improving air-conditioning efficiency and maximizing user convenience.

### CLAIM OF PRIORITY

This application makes reference to, incorporates the same herein, and claims all benefits accruing under 35 U.S.C. §119 from an application for SYSTEM AND METHOD FOR CONTROLLING MOVEMENT OF MOVABLE TERMINAL FOR MINICON, earlier filed in the Korean Intellectual Property Office on Jan. 11, 2005 and there duly assigned Serial No. 2005-2571.

### BACKGROUND OF THE INVENTION

1. Technical Field

The present invention relates to a system and method for controlling the movement of a movable terminal for a MiniCon, and more particularly, to a system and method for controlling the movement of a movable terminal for a MiniCon so that the MiniCon maintains a temperature in a number of partitioned indoor spaces within a set temperature range desired by a user while moving in the indoor spaces through a network.

2. Related Art

In general, a MiniCon is a type of air-conditioner that is capable of moving to any position in an indoor space, and performing air-conditioning for users by generating cooled air at that position so as to lower an ambient temperature and maintain the temperature within a certain range. Air-conditioners are divided into indoor units that have an air-conditioning system for circulating refrigerant so as to change indoor hot air into cool air and lower an indoor temperature, and outdoor units that have an air-conditioning system for discharging the indoor hot air along a refrigerant circulation route of the indoor unit.

The air-conditioner has rapidly become widely used due in part to its affordable price. In order to provide satisfactory air-conditioning to users, even in a number of partitioned spaces, a recent trend is to dispose a suitable indoor unit in the respective indoor spaces. However, since the indoor unit is stationary at a specific indoor position, air-conditioning is available only in a space where the indoor unit is disposed and not in a space where the indoor unit is not disposed. Consequently, users are still inconvenienced. To provide satisfactory air-conditioning to the users, it is necessary to dispose the indoor unit in all of the indoor spaces. However, this is considerably costly and is rarely realized due to its low marketability and distribution prospects.

As an alternative, a movable MiniCon capable of performing air-conditioning while moving from space to space has recently been developed. The MiniCon does not require tubes or ducts. This allows the MiniCon to freely move to any indoor position desired by the user, and then to perform air-conditioning. To perform more satisfactory air-conditioning, the MiniCon is paired with a stationary air-conditioner, efficiently maintaining a complementary relationship. The stationary air-conditioner and the MiniCon are collectively called a network air-conditioner. In this regard, a description of an air-conditioning system of the network air-conditioner and the MiniCon will be omitted.

However, it is necessary for a user to manually move the above-described movable MiniCon to a desired position in order to perform air-conditioning using the MiniCon. Furthermore, the user has to manually move the MiniCon to other indoor spaces when the indoor temperature reaches a suitable temperature range, resulting in an inconvenience. Moreover, if the user does not move the MiniCon at the appropriate time, air-conditioning efficiency is degraded.

### SUMMARY OF THE INVENTION

It is an object of the present invention to provide a system and method for controlling the movement of a movable terminal for a MiniCon so that the MiniCon performs air-conditioning while freely moving in at least one of a number of indoor spaces, thereby improving air-conditioning efficiency and maximizing user convenience.

It is another object of the present invention to provide a system and method for controlling the movement of a movable terminal for a MiniCon so that the MiniCon freely moves through at least one of a number of indoor spaces and performs air-conditioning depending on a range of a temperature sensed in the space(s).

According to an aspect of the present invention, there is provided a system for controlling the movement of at least one MiniCon that performs air-conditioning, the system including: a movable terminal docking with the MiniCon and moving along a predetermined path; and a server communicating with the movable terminal via a local area network, wherein the server sends to the movable terminal a control command to perform air-conditioning in indoor spaces along the predetermined path.

Preferably, the system further includes a control terminal for providing a user control command, destined for the movable terminal, to the server via either a wired communication network or a wireless communication network. Preferably, the control terminal is one of a personal digital assistant (PDA), a cellular phone, a notebook computer, and a networking personal computer (PC).

The system further includes an access point (AP) disposed between the server and the movable terminal for wirelessly communicating the control command from the server to the movable terminal.

Preferably, the movable terminal includes: a wireless local area communication module for gaining access to media in a competitive or non-competitive manner through an access point, and for receiving a control command from the server; a main controller for parsing the control command to execute a docking algorithm, a movement algorithm, and an air-conditioning algorithm on the MiniCon; and a robot controller for moving the movable terminal along a mapped path according to the docking algorithm and the movement algorithm. Preferably, the movable terminal further includes: a memory for storing mapping data for indoor spaces, and for providing the stored mapping data to the robot controller; an infrared sensor for sensing obstacles in the indoor spaces so as to provide a path and position data to the robot controller; a temperature sensor for sensing an indoor space temperature, and for providing the temperature to the main controller so as to thereby prompt execution of the air-conditioning algorithm; and a remote control for sending temperature control information as a remote control signal to the MiniCon according to the air-conditioning algorithm of the main controller.

Preferably, the MiniCon includes an external signal receiver located therein for receiving the remote control signal from the remote control, and for providing the remote control signal to an air-conditioning system of the MiniCon so as to trigger air-conditioning.

Preferably, the remote control is an infrared generator for generating an infrared signal corresponding to the temperature control information, and the external signal receiver is an infrared receiver for receiving the infrared signal, and for providing the infrared signal to the air-conditioning system.

Preferably, the system further includes a docking member positioned at one side of the movable terminal for docking the movable terminal with the MiniCon so that the movable terminal and the MiniCon move together as a unified body in response to a control command from the movable terminal. The docking member preferably includes: a magnetic body that is brought into contact with a housing of the MiniCon; and a current generator for generating an electromagnetic force around the magnetic body so as to maintain the contact.

Preferably, the server sends a control command to perform air-conditioning to a wireless local area communication module of a stationary main air-conditioner in a wireless local area network, the stationary main air-conditioner being at one side of the indoor space.

According to another aspect of the present invention, there is provided a system for controlling the movement of at least one MiniCon that performs air-conditioning, the system including: a movable terminal formed integrally with an air-conditioning system of the MiniCon and moving along a predetermined path; and a server communicating with the movable terminal via a local area network; wherein the server sends to the movable terminal a control command to perform air-conditioning in indoor spaces along the predetermined path.

Preferably, the system further includes a control terminal for providing a user control command, destined for the movable terminal, to the server via either a wired communication network or a wireless communication network.

Preferably, the system further includes an access point (AP) disposed between the server and the movable terminal for wirelessly communicating the control command from the server to the movable terminal.

Preferably, the movable terminal includes: a wireless local area communication module for gaining access to media in a competitive or non-competitive manner through an access point, and for receiving the control command from the server; a main controller for parsing the control command so as to execute a movement algorithm and air-conditioning algorithm on the MiniCon, and for selectively providing a temperature control command for the air-conditioning algorithm to the MiniCon air-conditioning system; and a robot controller for moving the MiniCon air-conditioning system to a desired position according to the movement algorithm. Preferably, the movable terminal further includes: a memory for storing mapping data for indoor spaces, and for providing the stored mapping data to the robot controller; an infrared sensor for sensing obstacles in the indoor spaces so as to provide a path and position data to the robot controller; and a temperature sensor for sensing an indoor space temperature, and for providing the temperature to the main controller so as to thereby prompt execution of the air-conditioning algorithm.

According to still another aspect of the present invention, there is provided a method for controlling the movement of a movable terminal so that a MiniCon is moved freely to a position desired by a user in a movement control system having at least one MiniCon for performing air-conditioning and a server for transmitting a control command to the movable terminal, the method including: the steps of: receiving the control command from the server, and determining whether the control command indicates performance of a manual mode or an automatic mode; receiving a movement control command to move the movable terminal so as to execute a docking algorithm for docking the movable terminal with the MiniCon, and a movement algorithm for moving the MiniCon into an indoor space, and receiving a temperature control command to execute an air-conditioning algorithm on the MiniCon, when it is determined that the control command indicates performance of the manual mode; and performing, by means of the movable terminal, a docking algorithm for docking the movable terminal with the MiniCon, a movement algorithm for moving the MiniCon into at least one indoor space, and an air-conditioning algorithm on the MiniCon in the indoor space, when it is determined that the control command indicates performance of the automatic mode.

Preferably, the method further includes the step of providing a user control command, destined for the movable terminal, from a user control terminal to the server via either a wired communication network or a wireless communication network.

Preferably, the docking algorithm includes the steps of: determining whether the movable terminal docks with the MiniCon, and when it does not dock with the MiniCon, locating the MiniCon in a mapping scheme while moving in the indoor spaces; and connecting a magnetic body with the MiniCon by means of an electromagnetic force when the MiniCon is located.

Preferably, the movement algorithm includes the steps of: determining whether to move the MiniCon toward a set indoor space; and moving the MiniCon until the MiniCon 8 reaches the set indoor space.

Preferably, the air-conditioning algorithm includes the steps of: generating a remote control signal to initiate the MiniCon; determining whether a current indoor space temperature is higher than a set temperature; and operating an air-conditioning system of the MiniCon to perform air-conditioning when the indoor space temperature is higher than the set temperature. Preferably, the method further includes the step of executing the movement algorithm when the indoor space temperature is lower than the set temperature. Preferably, the remote control signal is an infrared signal for local area communication.

Preferably, the automatic step further includes the step of determining a sequence in which air-conditioning is performed in at least one indoor space in a mapping scheme.

Preferably, the step of determining further includes the step of receiving the control command from the server via an access point (AP) over a wireless local area network.

According to still another aspect of the present invention, there is provided a method for controlling the movement of a movable terminal formed integrally with a MiniCon air-conditioning system performing air-conditioning for freely moving to a position desired by a user in a movement control system, the movement control system having a server for transmitting a control command to the movable terminal, the method including the steps of: receiving the control command from the server, and determining whether the control command indicates performance of a manual mode or an automatic mode; receiving a movement control command to move the movable terminal so as to execute a movement algorithm for moving the movable terminal into an indoor space, and receiving a temperature control command to execute an air-conditioning algorithm on a MiniCon, when it is determined that the control command indicates performance of the manual mode; and executing, by means of the movable terminal, a movement algorithm for moving the movable terminal into at least one indoor space, and an air-conditioning algorithm on the MiniCon in the indoor space, when it is determined that the control command indicates performance of the automatic mode.

Preferably, the method further includes the step of providing a user control command, destined for the movable terminal, from a user control terminal to the server via either a wired communication network or a wireless communication network.

Preferably, the automatic step further includes the step of determining a sequence in which air-conditioning is performed in at least one indoor space in a mapping scheme.

Preferably, the step of determining further includes the step of receiving the control command from the server via an access point (AP) over a wireless local area network.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a diagram of a system for controlling the movement of a movable terminal for a MiniCon according to the present invention;

FIG. 2 is a block diagram of a movable terminal for a MiniCon according to the present invention;

FIGS. 3A and 3B are flowcharts of a method for controlling the movement of a movable terminal for a MiniCon according to the present invention;

FIG. 4 is a block diagram of a movable terminal formed integrally with a MiniCon according to another embodiment of the present invention; and

FIGS. 5A and 5B are flowcharts of a method for controlling the movement of the movable terminal shown in FIG. 4.

### DETAILED DESCRIPTION OF THE PREFERRED EMBODIMENTS

Hereinafter, a system and method for controlling the movement of a movable terminal for a MiniCon according to the present invention will be described in detail with reference to the accompanying drawings.

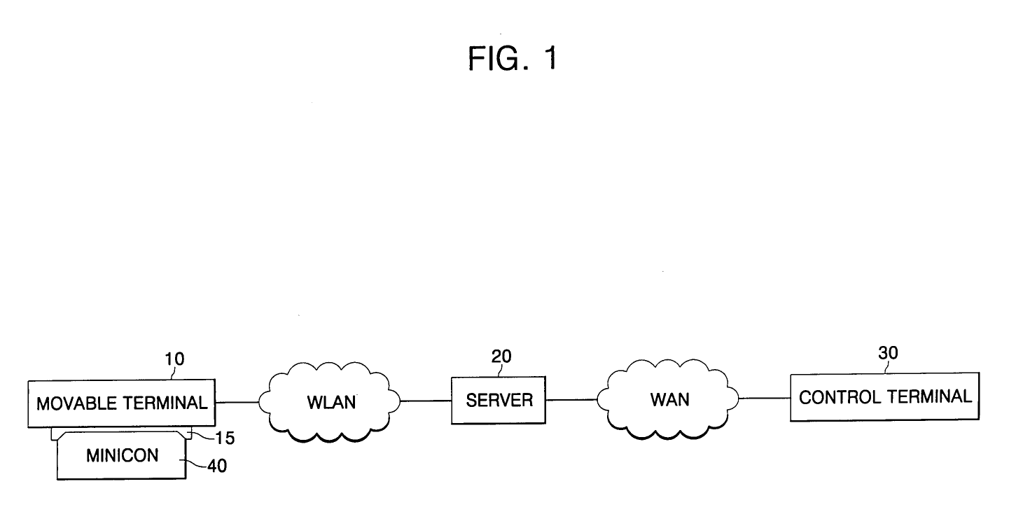

FIG. 1 is a diagram of a system for controlling the movement of a movable terminal for a MiniCon according to the present invention.

As shown in FIG. 1, the system for controlling the movement of the movable terminal has a movable terminal 10 docking with a MiniCon 40 and moving in an indoor space along a mapped path, a control terminal 30 for providing a control command to the movable terminal 10 so as to perform air-conditioning in an indoor space desired by a user, and a server 20 disposed between the control terminal 30 and the movable terminal 10 and communicating via a wired or wireless network for providing the control command to the movable terminal 10.

The MiniCon 40 is paired with a stationary main air-conditioner (not shown), and has freely movable drive wheels for movement to a position desired by the user. Furthermore, the MiniCon 40 guides cool air from the main air-conditioner so as to perform air-conditioning in a desired indoor space. The main air-conditioner has a terminal module (not shown) that performs local area wireless communication at one side to receive a control command for the performance of air-conditioning from the server 20, and suitably performs air-conditioning in the indoor space. Cooperation with the MiniCon 40 enables efficient air-conditioning.

The server 20 controls the operation of the movable terminal 10 and the MiniCon 40 by means of the control command. The movable terminal 10 parses the control command to execute a docking algorithm and a movement algorithm on the MiniCon 40. The movable terminal 10 connects to the MiniCon 40 according to the docking algorithm, and moves the MiniCon 40 toward a set indoor space according to the movement algorithm, and the movable terminal 10 inputs an air-conditioning command to the MiniCon 40 so as to perform air-conditioning in the indoor space according to an air-conditioning algorithm. At this time, it is assumed that the server 20 operates the main air-conditioner to perform air-conditioning in a specific indoor space.

However, since the server 20 receives an initiation command and a control command for air-conditioning (a user control command) from the movable terminal 10 rather than the control terminal 30, and responds to the commands, the movable terminal 10 may move to a relevant indoor space along a movement path according to an air-conditioning procedure, and then suitably perform air-conditioning.

For convenience, it is assumed that the “air-conditioning procedure” is a procedure in which a docking algorithm, a movement algorithm, and an air-conditioning algorithm are sequentially executed on the MiniCon 40. Air-conditioning in a certain temperature range at the MiniCon 40 is called simply “air-conditioning”.

The control terminal 30 communicates with the server 20 via either a remote (wide area) network or a home network (WAN). In particular, the control terminal 30 may be one of a personal digital assistant (PDA), a cellular phone, a notebook computer, a local area wired/wireless communication terminal, and a networking personal computer (PC), each having mobility for user convenience. Furthermore, transmission of the control command to the server is made by an embedded protocol.

The server 20 generates a control command. In response to the control command, the movable terminal 10 connects to the MiniCon 40, and moves together with the MiniCon 40 to perform an air-conditioning procedure. Movement with the MiniCon 40 requires the movable terminal 10 to be connected and fixed to the MiniCon 40. This is accomplished by a docking member 15 having a magnetic body. In this regard, a more powerful electromagnetic force may enhance a connection force to maintain a connection state. Furthermore, when the movable terminal 10 operates on a wireless local area network (WLAN), it receives the control command from the server 20 via an access point (AP, not shown), which provides an opportunity to access a medium in a competitive or non-competitive manner.

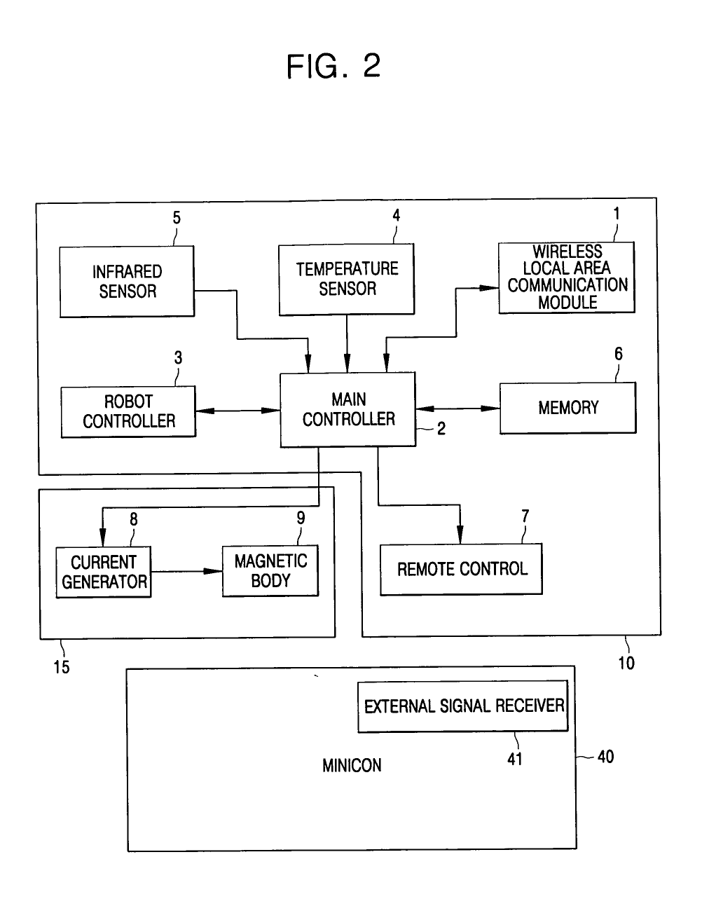

The configuration of the movable terminal 10, which is detachable with respect to the MiniCon 40 and performs the air-conditioning procedure, will be now described with reference to FIG. 2, which is a block diagram of a movable terminal for a MiniCon according to the present invention.

The configuration of the movable terminal 10 for moving the MiniCon 40 along a movement path in response to the control command from the server 20 will be described first. As shown in FIG. 2, the movable terminal 10 includes: a wireless local area communication module 1 for obtaining a chance to access media in a competitive or non-competitive manner through the access point, and for receiving the control command from the server 20; a main controller 2 for parsing the control command so as to selectively execute the docking algorithm, the movement algorithm, and the air-conditioning algorithm of the air-conditioning procedure on the MiniCon 40; and a robot controller 3 for moving the MiniCon 40 along a mapped path according to the docking algorithm and the movement algorithm in the air-conditioning procedure.

It is assumed that the robot controller 3 includes a mechanical robot mechanism for moving the MiniCon, and an algorithm for operating the mechanical robot mechanism.

The configuration of the movable terminal 10 that performs air-conditioning by the air-conditioning algorithm at the main controller 2 after moving the MiniCon 40 along the movement path will now be described. The movable terminal 10 includes: a memory 6 for storing mapping data for indoor spaces where air-conditioning is performed, and which provides the stored mapping data to the robot controller 3; an infrared sensor 5 for sensing obstacles in the indoor spaces so as to provide a path and position data to the robot controller 3; a temperature sensor 4 for sensing an indoor space temperature, and providing the temperature to the main controller 2 so as to thereby prompt execution of the air-conditioning algorithm; and a remote control 7 for instructing the MiniCon 40 to perform air-conditioning by sending temperature control information, as a remote control signal, to the MiniCon 40 according to the air-conditioning algorithm of the main controller 2.

The movement path and the position data provided by the infrared sensor 5 may have somewhat low reliability. To increase the reliability of the movement path and the position data, a camera-based vision system may be used instead of the infrared sensor 5. Such a vision system is capable of rapidly locating the MiniCon, and enabling the MiniCon to rapidly move along the movement path.

Furthermore, the MiniCon 4 has an external signal receiver 41 corresponding to the remote control 7 for receiving a remote control signal to initiate the air-conditioning system of the MiniCon 40, and for inputting the air-conditioning command to the air-conditioning system so that the temperature is maintained within a set range. When the air-conditioning system receives the remote control signal at the external signal receiver 41, it executes the air-conditioning algorithm to maintain the indoor space within a set range of temperature at its current position, and the air-conditioning algorithm properly controls various air-conditioning units to adjust an air flow and maintain the temperature of the indoor space substantially uniform within the set range.

The remote control 7 provides a suitable signal to the external signal receiver 41 located close to the remote control 7, enabling the MiniCon 40 to perform a function desired by the user. The remote control 7 is composed of an infrared generator, the reliability of which is relatively high. The external signal receiver 41 corresponds to the remote control 7, and induces secondary operation. The external signal receiver 41 is composed of an infrared receiver. The external signal receiver 41 provides a control signal to an intended unit in a non-contact manner. The external signal receiver 41 may be any one of a non-contact photo coupler for inputting a control signal at close range, an inductive coupler with RFID, a backscatter coupler, and the like.

Meanwhile, a docking member 15 is connected to the main controller 2. The docking member 15 operates according to the docking algorithm, is positioned outside the movable terminal 10, and docks the MiniCon 4 with powerful electromagnetic force. The docking member 15 has a magnetic body 9 that is in contact with and docked with a housing of the MiniCon 40, and a current generator 8 for generating a predetermined current and applying a predetermined electromagnetic force to the magnetic body 9 so as to reinforce the contact with the housing. The current generator 8 is equipped with a separate power supply.

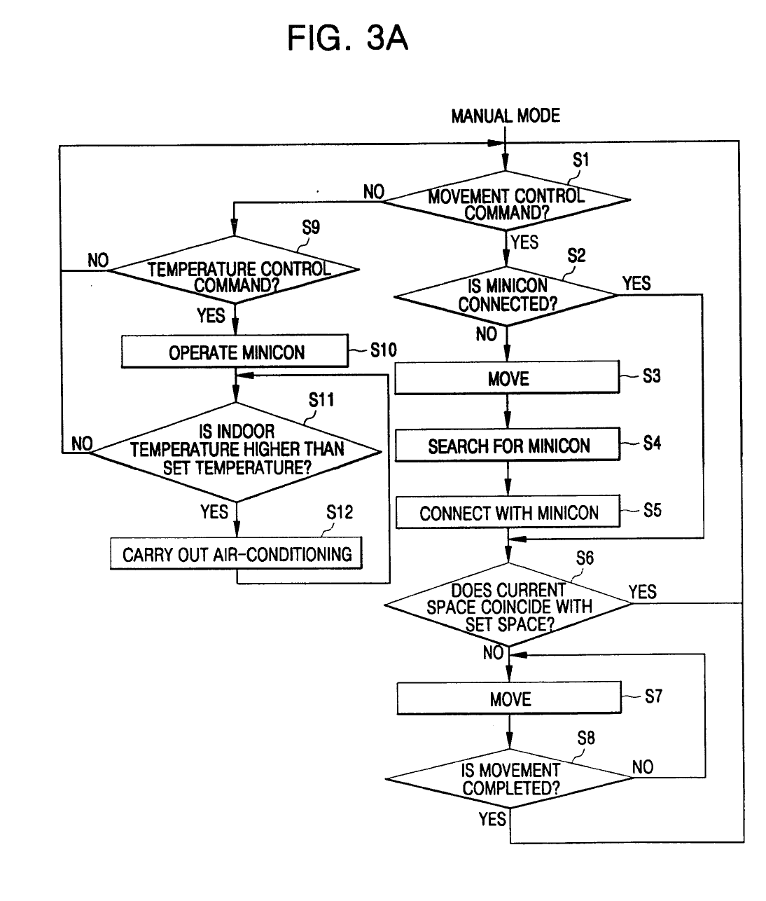

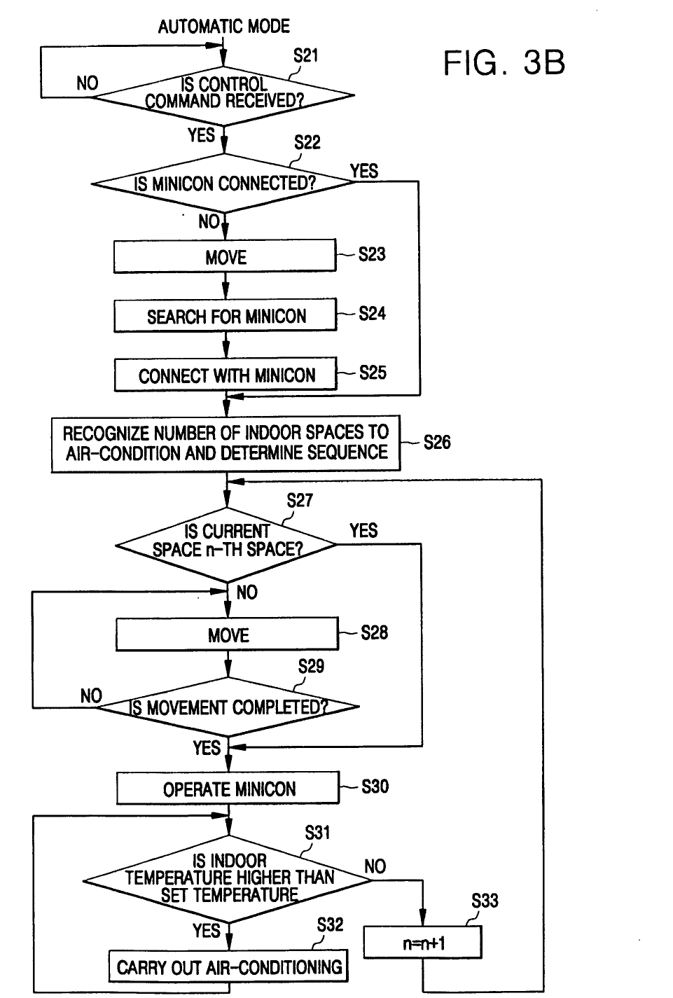

The operation of the system for controlling the movement of the movable terminal according to the present invention as described above is shown in FIGS. 3A and 3B. It is assumed that the control terminal 30 sends a user control command to the server 20 and, in turn, the server 20 sends the control command to the movable terminal 10 via an access point (AP). It is also assumed that the control command is classified into a manual mode control command and an automatic mode control command, in which the automatic mode follows the air-conditioning procedure while the manual mode follows a procedure including moving and air-conditioning.

FIGS. 3A and 3B are flowcharts of a method for controlling the movement of a movable terminal for a MiniCon according to the present invention.

First, as shown in FIG. 3A, when the control terminal 30 sends the manual mode control command to the movable terminal 10 via the server 20, the movable terminal 10 determines whether the control command is a movement control command for moving the MiniCon or a temperature control command for performing air-conditioning (S1 and S9). When the control command is the movement control command for moving the MiniCon, the movable terminal 10 performs a moving operation on the MiniCon according to the docking and movement algorithms. When the control command is the temperature control command for performing air-conditioning, the movable terminal 10 performs an air-conditioning operation according to the air-conditioning algorithm.

When the control command is the movement control command, the movable terminal 10 recognizes that the control command is a command to dock with the MiniCon 40 and move it to a given indoor space, and sequentially executes the docking algorithm and the movement algorithm.

The movable terminal 10 determines whether it is docked and connected with the MiniCon 40 according to the docking algorithm (S2). When it is determined that the movable terminal 10 is docked and connected with the MiniCon 40, the process goes to a next step (S6). When the movable terminal 10 is not connected with the MiniCon 40, the movable terminal 10 moves to the position of the MiniCon 40 along the mapped movement path via the robot controller 3 (S3). The movable terminal 10 locates the MiniCon 40 using the infrared sensor while moving (S4), and then attempts to dock with the MiniCon 40. Upon docking, the electromagnetic force generated by the current generator 8 of the docking member 15, which is positioned at one side of the movable terminal 10, is applied to the magnetic body 9 so that a connection force is produced around the magnetic body 9. The movable terminal 10 then moves to and docks with the MiniCon 40 (S5).

In this regard, by substituting the vision system for the infrared sensor 5 so as to search for the movement path and the position of the MiniCon 40, the movable terminal 10 is able to rapidly locate and dock with the MiniCon 40 with improved reliability.

Next, the movable terminal 10, which has moved to and docked with the MiniCon 40, reads out the mapping data from the memory 6 so as to recognize, through the infrared sensor 5, the position of an indoor space where the movable terminal 10 is positioned. The movable terminal 10 also determines whether the recognized indoor space corresponds to a set indoor space which is input together with the initial movement control command. If it is determined that the set indoor space and the searched indoor space coincide (S6), the movable terminal 10 recognizes that it has completed execution of the movement control command and enters a standby state until it receives the temperature control command. When the movable terminal 10 in the standby state receives the movement control command (S1) to move to another indoor space, it repeats steps S2 to S6 to locate the MiniCon and determine whether it has reached the set indoor space.

When the searched indoor space does not coincide with the set indoor space (S6), the movable terminal 10 docked with the MiniCon again executes the movement algorithm so as to move to the set indoor space (S7). That is, the movable terminal 10 reads out the mapping data from the memory 6 in order to recognize the position of the set indoor space to move to, and operates the robot moving mechanism through the robot controller 3 to move to the set indoor space. Of course, the movable terminal 10 moves along the mapped movement path by referring to the position data along the predetermined path that is input from the infrared sensor 5 (S7). The movable terminal 10 continuously determines whether it has reached the set indoor space by referring to the mapping data while moving until it completes the movement (S8). At this point, since the set indoor space and the searched indoor space coincide, the movable terminal 10 determines that it has completed execution of the movement control command, and enters the standby state until it receives the temperature control command.

In the standby state, the movable terminal 10 receives a temperature control command to maintain an indoor air temperature at a proper reference value from the control terminal 30 via the server 20 (S9). The main controller 2 wirelessly transmits a remote control signal for initiation of the MiniCon 40 to the external signal receiver 41 of the MiniCon 40 via the remote control 7. At the same time, since the remote control signal includes temperature control information for adjusting an amount of air at a certain temperature so that the MiniCon 40 automatically adjusts itself to attain and maintain the set temperature, the external signal receiver 41 allows the air-conditioning system of the MiniCon 40 to operate by itself (S10).

Accordingly, the MiniCon 40 performs air-conditioning in the indoor space according to the air-conditioning algorithm through its temperature monitoring system. That is, the main controller 2 checks the temperature of a current indoor space measured by the temperature 8 sensor 4 to determine whether the temperature is higher than the set temperature (S11). When the current indoor space temperature is higher than the set temperature, the main controller 2 controls the MiniCon 4 to carry out air-conditioning (S12). When the current indoor space temperature is not higher than the set temperature, the main controller 2 displays the current temperature, and instructs the server 20 to enable input of a next control command via the movable terminal 10. At this time, the next control command may be input by the user.

In this case, it may be possible to check the indoor space temperature using a temperature sensor (not shown) of the MiniCon 40 rather than the movable terminal 10. In executing the air-conditioning algorithm, the movable terminal 10 is allowed to send the remote control signal for initiation of the MiniCon 40 to the external signal receiving unit 41 after checking the temperature using its temperature sensor 4.

As shown in FIG. 3B, when the control terminal 30 sends the automatic mode control command to the movable terminal 10 via the server 20, the movable terminal 10 determines whether the control command is a command to automatically perform all sequential operations (S21). When the control command is the automatic mode control command for performance of air-conditioning by the MiniCon, the movable terminal 10 sequentially performs movement and air-conditioning operations on the MiniCon according to the docking, movement, and air-conditioning algorithms.

When the control command is the automatic mode control command, the movable terminal 10 recognizes that the control command is a command to dock with the MiniCon 40 and to move it to a given indoor space, and sequentially executes the docking, movement, and air-conditioning algorithms.

Specifically, the movable terminal 10 determines whether the movable terminal 10 is docked and connected with the MiniCon 40 according to the docking algorithm (S22). If it is found that the movable terminal 10 is docked and connected with the MiniCon 40, the process goes to a next step (S26). On the other hand, if the movable terminal 10 is not connected with the MiniCon 40, the movable terminal 10 moves along the mapped movement path to a position of the MiniCon 40, using the robot controller 3 (S23). The movable terminal 10 locates the MiniCon 40 through the infrared sensor 5 while moving (S24), and then attempts to dock with the MiniCon 40. Upon docking, the electromagnetic force generated by the current generator 8 in the docking member 15, which is positioned at one side of the movable terminal 10, is applied to the magnetic body 9 to produce a connection force around the magnetic body 9. The movable terminal 10 then moves to and docks with the MiniCon 40 (S25).

In the latter regard, by using the vision system instead of the infrared sensor 5 to search for the movement path and the position of the MiniCon 40, the movable terminal 10 is able to rapidly locate and dock with the MiniCon 40 with improved reliability.

After docking, the main controller 2 reads out the mapping data from the memory 6 in order to recognize a number (N) of preset indoor spaces, and to determine an air-conditioning sequence to move from a current position and perform air-conditioning from a starting indoor space to a last indoor space (S26). Furthermore, the main controller 2 recognizes, through the infrared sensor 5, the position of the movable terminal 10 which moves while in a docked state with the MiniCon 40 by referring to the mapping data stored in the memory 6. The recognized position may be in one of the number (N) of indoor spaces. However, since the recognized position may be on a path between the indoor spaces, the main controller 2 sequentially executes the movement algorithm for movement along the given movement path from the recognized position and the air-conditioning algorithm. That is, the main controller 2 determines whether the recognized position corresponds to an indoor space from which air-conditioning is initiated according to the air-conditioning sequence (S27).

If it is determined that the recognized position corresponds to the indoor space according to the air-conditioning sequence, the main controller 2 executes the air-conditioning algorithm. On the other hand, if the recognized position is on the path to the indoor space rather than coinciding with the indoor space according to the air-conditioning sequence, the main controller 2 executes the movement algorithm.

If the searched position is not the set indoor space in the air-conditioning sequence, the movable terminal 10 docked with the MiniCon re-executes the movement algorithm to the set indoor space. That is, the movable terminal 10 reads out the mapping data from the memory 6 in order to recognize the position of the set indoor space, and executes the robot movement mechanism at the robot controller 3 to move to the set indoor space. Of course, the movable terminal 10 moves along the mapped movement path by referring to the position data about the movement path that is input from the infrared sensor 5 (S28). The movable terminal 10 continuously determines whether it has reached the set indoor space by referring to the mapping data while moving to the set indoor space until it completes its movement (S29).

The main controller 2 of the movable terminal 10 then instructs the remote control 7 to send a remote control signal for initiation of the MiniCon 40 to the external signal receiver 41 of the MiniCon 40. At the same time, since the remote control signal includes temperature control information for adjusting air flow and a target temperature so that the MiniCon 40 automatically adjusts itself to attain and maintain the set temperature, the external signal receiver 41 allows the air-conditioning system of the MiniCon 40 to operate by itself (S30).

Accordingly, the MiniCon 40 performs air-conditioning according to the air-conditioning algorithm using its temperature monitoring system in the indoor space. That is, the main controller 2 receives a current indoor space temperature from the temperature sensor 4 and determines whether the temperature is higher than the set temperature (S31). When the current indoor space temperature is higher than the set temperature, the main controller 2 controls the MiniCon 4 to carry out air-conditioning (S32). When the current indoor space temperature is not higher than the set temperature, the main controller 2 displays the current temperature to notify the server 20, and re-executes the movement algorithm so that the movable terminal 10 moves into a next indoor space according to a next air-conditioning sequence (n=n+1) by executing the movement algorithm (S33).

In the latter regard, it is possible to determine the indoor space temperature using a temperature sensor (not shown) of the MiniCon 40 rather than the movable terminal 10. In other words, in executing the air-conditioning algorithm, the movable terminal 10 is allowed to send the remote control signal for initiation of the MiniCon 40 to the external signal receiving unit 41 after checking the temperature using its temperature sensor 4.

The air-conditioning procedure is completed within all the set indoor spaces by sequentially repeating S27 to S29 to move to the next indoor space, and S30 to S32 to execute the air-conditioning algorithm.

In the present invention as described above, the movable terminal 10 is separated from the MiniCon 40. For more practical use, the movable terminal 10 may be formed integrally with the MiniCon 40, and in this case, the present invention has a different configuration and air-conditioning procedure.

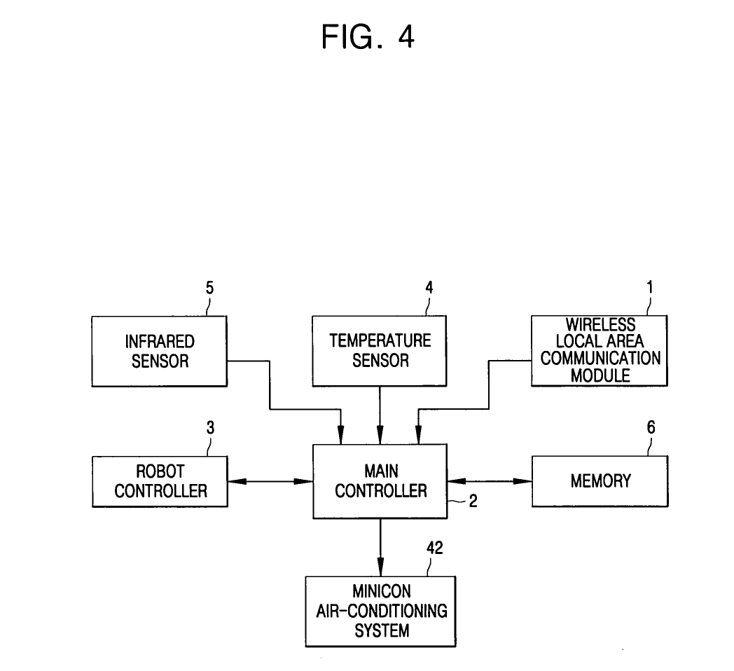

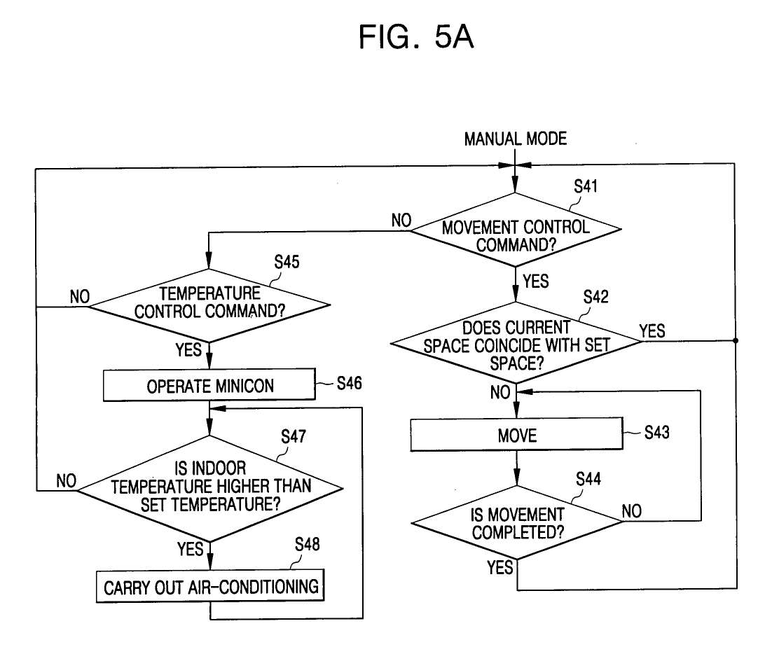

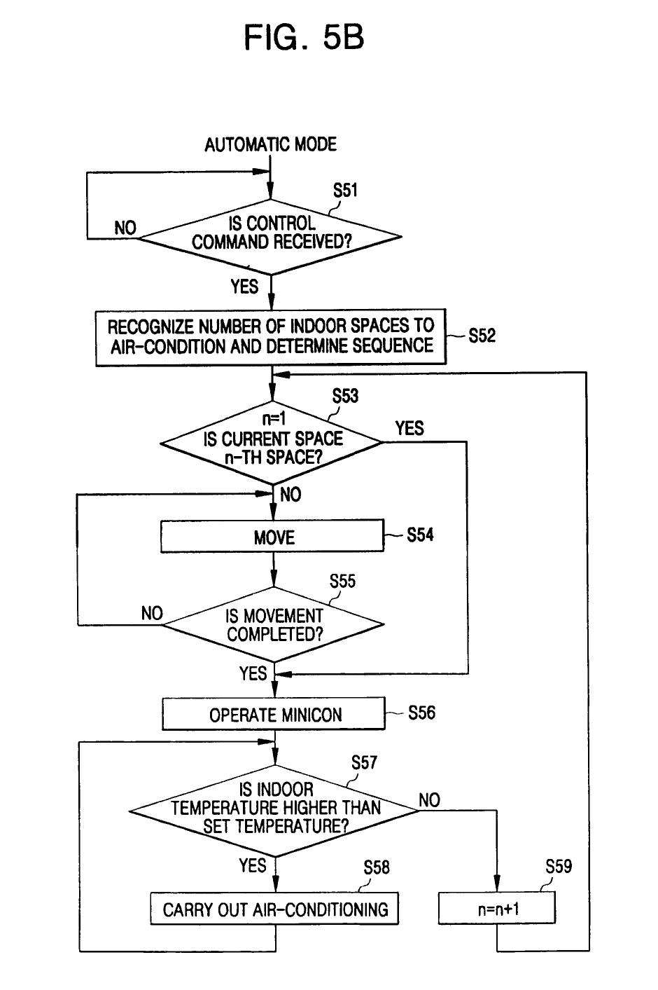

A movable terminal for a MiniCon and a method for controlling the movement thereof according to another embodiment of the present invention are shown in FIGS. 4, 5A and 5B.

FIG. 4 is a block diagram of a movable terminal formed integrally with a MiniCon according to another embodiment of the present invention, and FIGS. 5A and 5B are flowcharts of a method for controlling the movement of the movable terminal shown in FIG. 4.

Referring to FIG. 4, the configuration of the movable terminal 10 for moving the MiniCon 40 according to the movement algorithms of the air-conditioning procedure in response to the control command from the server 20 will be described. The movable terminal 10 according to the present embodiment includes: a wireless local area communication module 1 for obtaining a chance to access media in a competitive or non-competitive manner through the access point, and for receiving a control command from the server 20; a main controller 2 for parsing the control command to sequentially execute a movement algorithm and air-conditioning algorithm according to an air-conditioning procedure on the MiniCon 40, and for selectively providing a temperature control command for the air-conditioning procedure to a MiniCon air-conditioning system 42; and a robot controller 3 for moving the MiniCon air-conditioning system 42 along a mapped path according to the movement algorithm of the air-conditioning procedure.

It is assumed that the robot controller 3 includes a mechanical robot mechanism for moving the MiniCon and an algorithm for operating the mechanical robot mechanism.

The configuration of the movable terminal 10 that performs air-conditioning according to the air-conditioning algorithm at the main controller 2 after moving the MiniCon 40 along the movement path will be now described. The movable terminal 10 includes: a memory 6 for storing mapping data for indoor spaces where air-conditioning is performed, and for providing the stored mapping data to the robot controller 3; an infrared sensor 5 for sensing obstacles in the indoor spaces so as to provide a path and position data to the robot controller 3; a temperature sensor 4 for sensing an indoor space temperature, and for providing the temperature to the main controller 2 so as to thereby prompt execution of the air-conditioning algorithm; and a mini air-conditioning system 42 for receiving temperature control information for performance of air-conditioning according to the air-conditioning algorithm of the main controller 2.

The reliability of the movement path and the position data provided by the infrared sensor 5 may be somewhat low. To increase the reliability of the movement path and the position data, the infrared sensor 5 may be replaced by a camera-based vision system. The vision system is capable of rapidly locating the MiniCon and enabling the MiniCon to rapidly move along the movement path.

Upon receipt of a temperature control command from the main controller, the MiniCon air-conditioning system 42 executes the air-conditioning algorithm so as to maintain the temperature of the indoor space at a current position within a set temperature range. The air-conditioning algorithm properly controls various air-conditioning units to adjust air flow and to maintain the temperature in the indoor space substantially uniform within the set temperature range.

Meanwhile, since the movable terminal 10 need not have the docking member 15 (FIG. 1) for docking the MiniCon 4 with a powerful electromagnetic force, the movable terminal 10 does not have the magnetic body 9 for contacting and docking with the housing of the MiniCon 40, nor the current generator 8 for providing an electromagnetic force around the magnetic body 9 to increase the contact and connection with the housing.

The method for controlling the movement according to the present invention as described above is shown in FIGS. 5A and 5B, which are flowcharts of a method for controlling the movement of the movable terminal shown in FIG. 4. It is assumed that the control terminal 30 sends a user control command to the server 20, and in turn, the server 20 sends the control command to the movable terminal 10 via an access point (AP). It is also assumed that the control command is a manual mode control command or an automatic mode control command, and that the automatic mode follows an air-conditioning procedure, while the manual mode follows a procedure including moving and air-conditioning.

As shown in FIG. 5A, when the control terminal 30 sends the manual mode control command to the movable terminal 10 via the server 20, the movable terminal 10 determines whether the control command is a movement control command to move the MiniCon or a temperature control command to perform air-conditioning (S41 and S45). When the control command is a movement control command to move the MiniCon, the movable terminal 10 performs a moving operation on the MiniCon according to the movement algorithm. When the control command is a temperature control command to perform air-conditioning, the movable 11 terminal 10 performs air-conditioning according to the air-conditioning algorithm. In this regard, the docking algorithm is not performed since the movable terminal 10 is integrated into the MiniCon 40.

When the control command is the movement control command, the movable terminal 10 recognizes that the control command is a command to move the MiniCon 40 into a given indoor space, and executes the movement algorithm.

According to the movement algorithm, the movable terminal 10 formed integrally with the MiniCon reads out the mapping data from the memory 6 in order to recognize the position of an indoor space where the movable terminal 10 is positioned by referring to the position data from the infrared sensor 5. The movable terminal 10 also determines whether the recognized indoor space corresponds to a set indoor space which is input together with the initial movement control command (S42). If it is determined that the set indoor space and the searched indoor space coincide, the movable terminal 10 recognizes that it has completed the movement control command and enters a standby state until it receives a next temperature control command (return to S41). When the movable terminal 10 in the standby state receives another movement control command to move into another indoor space (S41), it repeats the foregoing step to determine whether it has reached the set indoor space (S42).

When the searched indoor space does not coincide with the set indoor space, the movable terminal 10 executes the movement algorithm to move to the set indoor space (S43). That is, the movable terminal 10 reads out the mapping data from the memory 6 in order to recognize the position of the set indoor space to move to, and operates the robot moving mechanism through the robot controller 3 to move to the set indoor space. Of course, the movable terminal 10 moves along the mapped movement path by referring to the position data along the predetermined path that is input from the infrared sensor 5. The movable terminal 10 continuously determines whether it has reached the set indoor space by referring to the mapping data while moving until it completes the movement (S44). At this point, since the set indoor space and the searched indoor space coincide, the movable terminal 10 determines that it has completed execution of the movement control command and enters the standby state (return to S41) until it receives a next temperature control command.

According to the air-conditioning algorithm, in the standby state, the movable terminal 10 receives a temperature control command to maintain an indoor air temperature at a proper reference value from the control terminal 30 via the server 20 (S45). The main controller 2 inputs to the MiniCon 40 an initiation control signal for initiation of the MiniCon air-conditioning system 42. At the same time, since the initiation control signal includes temperature control information for adjusting air flow and a target temperature so that the MiniCon air-conditioning system 42 can adjust itself to attain and maintain the set temperature, the MiniCon air-conditioning system 42 operates by itself (S46).

Accordingly, the MiniCon air-conditioning system 42 performs air-conditioning in the indoor space according to the air-conditioning algorithm through its temperature monitoring system. That is, the main controller 2 receives the temperature of a current indoor space from the temperature sensor 4 and determines whether the temperature is higher than the set temperature (S47). When the current indoor space temperature is higher than the set temperature, the main controller 2 controls the MiniCon air-conditioning system 42 to carry out air-conditioning (S48). When the current indoor space temperature is not higher than the set temperature, the main controller 2 displays the current temperature so as to indicate it to the server 20, and awaits input of a next control command via the movable terminal 10 (return to S41). At this time, the next control command may be input by the user.

Here, it may be possible to check the indoor space temperature using a temperature sensor (not shown) of the MiniCon air-conditioning system 42 rather than the movable terminal 10. In executing the air-conditioning algorithm, the movable terminal 10 is allowed to send the initiation control signal to initiate the MiniCon air-conditioning system 42 to the MiniCon 40 after checking the temperature using the temperature sensor 4 of the movable terminal 10.

Meanwhile, as shown in FIG. 5B, when the control terminal 30 sends the automatic X mode control command to the movable terminal 10 via the server 20, the movable terminal 10 determines whether the control command is a command to automatically perform all sequential operations (S51). When the control command is the automatic mode control command to perform air-conditioning by the MiniCon, the movable terminal 10 sequentially performs moving and air-conditioning by the MiniCon according to the movement and air-conditioning algorithms.

When the control command is the automatic mode control command, the movable terminal 10 recognizes that the control command is a command to move to a given indoor space, and sequentially executes the movement algorithm and air-conditioning algorithm.

According to the movement algorithm, the main controller 2 of the movable terminal 110 reads out the mapping data from the memory 6 in order to recognize a number (N) of preset service indoor spaces, determines an air-conditioning sequence in which the movable terminal 10 moves from a current position, and then performs air-conditioning from a first indoor space to a last indoor space (S52). Furthermore, the main controller 2 recognizes a position of the combined movable terminal 10 and MiniCon 40 through the infrared sensor 5 by referring to the mapping data stored in the memory 6. The recognized position may be one of the number (N) of recognized indoor spaces, or may be on a path between indoor spaces. Accordingly, the movable terminal 10 moves along the given movement path from that position, and then performs air-conditioning. To this end, the main controller 2 determines whether the position is in the indoor space from which air-conditioning begins according to the air-conditioning sequence (S53).

When it is determined that the position is a set indoor space included in the air-conditioning sequence, the movable terminal 10 executes the air-conditioning algorithm and then proceeds with a next algorithm. When it is determined that the position is on a path between set indoor spaces included in the air-conditioning sequence, the movable terminal 10 executes the movement algorithm.

If the searched position is not among the set indoor spaces included in the air-conditioning sequence, the movable terminal 10 with the MiniCon 40 re-executes the movement algorithm to move to the set indoor space. That is, the movable terminal 10 reads out the mapping data from the memory 6 to recognize the position of the set indoor space to move to, and operates the robot moving mechanism through the robot controller 3 to move to the set indoor space. Of course, the movable terminal 10 moves along the mapped movement path by referring to the position data along the predetermined path that is input from the infrared sensor 5 (S54). The movable terminal 10 continuously determines whether it has reached the set indoor space by referring to the mapping data while moving, until it completes the movement (S55).

By using the vision system instead of the infrared sensor 5 to search for the movement path and the position of the movable terminal 10, the movable terminal 10 is able to rapidly locate the MiniCon 40 with improved reliability.

The main controller 2 of the movable terminal 10 then instructs the remote control 7 to send an initiation control signal for initiation of the MiniCon air-conditioning system 42 to the MiniCon 40. At the same time, since the initiation control signal includes temperature control information for adjusting air flow and a target temperature so that the MiniCon air-conditioning system 42 can adjust itself to attain and maintain the set target temperature, the MiniCon air-conditioning system 42 operates by itself (S56).

Accordingly, the MiniCon air-conditioning system 42 performs air-conditioning in the indoor space according to the air-conditioning algorithm in its temperature monitoring system. That is, the main controller 2 receives a current indoor space temperature from the temperature sensor 4, and determines whether the temperature is higher than the set temperature (S57). When the current indoor space temperature is higher than the set temperature, the main controller 2 controls the MiniCon air-conditioning system 42 to carry out air-conditioning (S58). When the current indoor space temperature is not higher than the set temperature, the main controller 2 displays the current temperature and executes the movement algorithm so that the movable terminal 10 moves into an indoor space according to a next air-conditioning sequence (n=n+1) (S59).

In the latter regard, it is possible to check the indoor space temperature using a temperature sensor (not shown) of the MiniCon air-conditioning system 42 rather than the movable terminal 10. In other words, in executing the air-conditioning algorithm, the movable terminal 10 is allowed to input the initiation control signal for initiation of the MiniCon air-conditioning system 42 to the MiniCon 40 after checking the temperature using its temperature sensor 4.

The air-conditioning procedure is completed within all the set indoor spaces by sequentially repeating steps S53 to S55 to move to the next indoor space, and steps S56 to S58 to execute the air-conditioning algorithm.

As described above, the present invention enables the MiniCon to freely move into at least one of a number of indoor spaces and perform air-conditioning.

According to the present invention, the MiniCon is capable of performing air-conditioning while freely moving into at least one of a number of indoor spaces, thus improving air-conditioning efficiency and maximizing user convenience.

Furthermore, according to the present invention, the MiniCon is capable of freely moving into at least one of a number of indoor spaces and performing air-conditioning depending on a range of a temperature sensed in the space. Accordingly, it is possible to maintain the indoor space at a desired temperature at all times so as to create a comfortable environment without over air-conditioning.

While the present invention has been described with reference to exemplary embodiments thereof, it will be understood by those skilled in the art that various changes in form and detail may be made therein without departing from the scope of the present invention as defined by the following claims.

What is claimed is:

1. A system for controlling movement of a MiniCon which performs air-conditioning, the system comprising:
a movable terminal for docking with the MiniCon, and for moving along a predetermined path; and
a server for communicating with the movable terminal via a local area network;
wherein the server sends, to the movable terminal, a control command for performance of the air-conditioning in indoor spaces located along the predetermined path.

2. The system according to claim 1, further comprising a control terminal for providing a user control command, destined for the movable terminal, to the server via one of a wired communication network and a wireless communication network.

3. The system according to claim 2, wherein the control terminal is one of a personal digital assistant (PDA), a cellular phone, a notebook computer, and a networking personal computer (PC).

4. The system according to claim 1, further comprising an access point disposed between the server and the movable terminal for wirelessly communicating the control command from the server to the movable terminal.

5. The system according to claim 1, wherein the movable terminal comprises:
a wireless local area communication module for gaining access to media in one of a competitive manner and a non-competitive manner through an access point, and for receiving the control command from the server;
a main controller for parsing the control command to execute a docking algorithm, a movement algorithm, and an air-conditioning algorithm on the MiniCon; and
a robot controller for moving the movable terminal along a mapped path according to the docking algorithm and the movement algorithm.

6. The system according to claim 5, wherein the movable terminal further comprises:
a memory for storing mapping data for indoor spaces, and for providing the stored mapping data to the robot controller;
an infrared sensor for sensing obstacles in the indoor spaces so as to provide a path and position data to the robot controller;
a temperature sensor for sensing an indoor space temperature, and for providing the sensed indoor space temperature to the main controller so as to prompt execution of the air-conditioning algorithm; and
a remote control unit for sending temperature control information as a remote control signal to the MiniCon according to the air-conditioning algorithm of the main controller.

7. The system according to claim 6, wherein the MiniCon comprises an air-conditioning system, and an external signal receiver for receiving the remote control signal from the remote control unit, and for providing the remote control signal to the air-conditioning system so as to trigger the air-conditioning.

8. The system according to claim 7, wherein the remote control unit comprises an infrared generator for generating an infrared signal corresponding to the temperature control information; and
wherein the external signal receiver comprises an infrared receiver for receiving the infrared signal, and for providing the infrared signal to the air-conditioning system.

9. The system according to claim 1, further comprising a docking member positioned at one side of the movable terminal for docking the movable terminal with the MiniCon so that the movable terminal and the MiniCon move together as a unified body in response to a control command from the movable terminal.

10. The system according to claim 9, wherein the docking member comprises:
a magnetic body which is brought into contact with a housing of the MiniCon; and
a current generator for generating an electromagnetic force around the magnetic body so as to maintain the contact with the housing of the MiniCon.

11. The system according to claim 1, wherein the server sends the control command for performance of the air-conditioning to a wireless local area communication module of a stationary main air-conditioner in a wireless local area network, the stationary main air-conditioner being at one side of the indoor space.

12. A system for controlling movement of a MiniCon which performs air-conditioning, the system comprising:
a movable terminal formed integrally with an air-conditioning system of the MiniCon and moving along a predetermined path; and
a server communicating with the movable terminal via a local area network;
wherein the server sends, to the movable terminal, a control command for performance of the air-conditioning in indoor spaces located along the predetermined path.

13. The system according to claim 12, further comprising a control terminal for providing a user control command destined for the movable terminal, to the server via one of a wired communication network and a wireless communication network.

14. The system according to claim 13, further comprising an access point disposed between the server and the movable terminal for wirelessly communicating the control command from the server to the movable terminal.

15. The system according to claim 14, wherein the movable terminal comprises:
a wireless local area communication module for gaining access to media in one of a competitive manner and a non-competitive manner through an access point, and for receiving the control command from the server;
a main controller for parsing the control command to execute a movement algorithm and an air-conditioning algorithm on the MiniCon, and for selectively providing a temperature control command for the air-conditioning algorithm to the air-conditioning system of the MiniCon; and
a robot controller for moving the air-conditioning system of the MiniCon to a desired position according to the movement algorithm.

16. The system according to claim 15, wherein the movable terminal further comprises:
a memory for storing mapping data for indoor spaces, and for providing the stored mapping data to the robot controller;
an infrared sensor for sensing obstacles in the indoor spaces so as to provide a path and position data to the robot controller; and
a temperature sensor for sensing an indoor space temperature, and for providing the sensed indoor space temperature to the main controller so as to prompt execution of the air-conditioning algorithm.

17. A method for controlling movement of a movable terminal so as to freely move a MiniCon to a position desired by a user in a movement control system having at least one MiniCon for performing air-conditioning and a server for transmitting a control command to the movable terminal, the method comprising the steps of:
(a) receiving the control command from the server and determining whether the control command indicates performance of one of a manual mode and an automatic mode;
(b) receiving a movement control command to move the movable terminal so as to execute a docking algorithm for docking the movable terminal with the MiniCon, and a movement algorithm for moving the MiniCon into an indoor space, and receiving a temperature control command to execute an air-conditioning algorithm on the MiniCon, when it is determined that the control command indicates performance of the manual mode; and
(c) performing, by means of the movable terminal, a docking algorithm for docking the movable terminal with the MiniCon, a movement algorithm for moving the MiniCon into at least one indoor space, and an air-conditioning algorithm on the MiniCon in the indoor space, when it is determined that the control command indicates performance of the automatic mode.

18. The method according to claim 17, further comprising the step of providing a user control command, destined for the movable terminal, from a user control terminal to the server via one of a wired communication network and a wireless communication network.

19. The method according to claim 17, wherein the docking algorithm comprises the steps of:
determining whether the movable terminal docks with the MiniCon, and when it is determined that the movable terminal does not dock with the MiniCon, locating the MiniCon in a mapping scheme while moving in the indoor spaces; and
connecting a magnetic body with the MiniCon by means of an electromagnetic force when the MiniCon is located in the mapping scheme.

20. The method according to claim 17, wherein the movement algorithm comprises the steps of:
determining whether to move the MiniCon toward a set indoor space; and
moving the MiniCon until the MiniCon reaches the set indoor space.

21. The method according to claim 17, wherein the air-conditioning algorithm comprises the steps of:
generating a remote control signal to initiate the MiniCon;
determining whether a current indoor space temperature is higher than a set temperature; and
operating an air-conditioning system of the MiniCon to perform the air-conditioning when the indoor space temperature is higher than the set temperature.

22. The method according to claim 21, further comprising the step of executing the movement algorithm when the indoor space temperature is lower than the set temperature.

23. The method according to claim 21, wherein the remote control signal comprises an infrared signal for local area communication.

24. The method according to claim 17, wherein step (c) further comprises the step of determining a sequence in which air-conditioning is performed in said at least one indoor space in a mapping scheme.

25. The method according to claim 17, wherein step (c) further comprises the step of receiving the control command from the server via an access point over a wireless local area network.

26. A method for controlling movement of a movable terminal formed integrally with a MiniCon air-conditioning system for performing air-conditioning so as to freely move the movable terminal to a position desired by a user in a movement control system having a server for transmitting a control command to the movable terminal, the method comprising the steps of:
(a) receiving the control command from the server and determining whether the control command indicates performance of one of a manual mode and an automatic mode;
(b) receiving a movement control command to move the movable terminal so as to execute a movement algorithm for moving the movable terminal into an indoor space, and receiving a temperature control command to execute an air-conditioning algorithm on a MiniCon, when it is determined that the control command indicates performance of the manual mode; and
(c) executing, by means of the movable terminal, a movement algorithm for moving the movable terminal into said at least one indoor space, and an air-conditioning algorithm on the MiniCon in said at least one indoor space, when it is determined that the control command indicates performance of the automatic mode.

27. The method according to claim 26, further comprising the step of providing a user control command, destined for the movable terminal, from a user control terminal to the server via one of wired communication network and a wireless communication network.

28. The method according to claim 26, wherein step (c) further comprises the step of determining a sequence in which the air-conditioning is performed in said at least one indoor space in a mapping scheme.

29. The method according to claim 26, wherein step (c) further comprises the step of receiving the control command from the server via an access point over a wireless local area network.
